(19) United States
(12) Patent Application Publication
(10) Pub. No.: US 2018/0006592 A1
(43) Pub. Date: Jan. 4, 2018

(54) SWITCHED RELUCTANCE MOTOR AND METHOD THEREFORE

(71) Applicant: Punch Powertrain N.V., Sint-Truiden (BE)

(72) Inventors: Saphir Elias FAID, Sint-Truiden (BE); Fabrice BOON, Sint-Truiden (BE)

(21) Appl. No.: 15/543,696

(22) PCT Filed: Jan. 15, 2016
(86) PCT No.: PCT/EP2016/050786

§ 371 Date: Jul. 14, 2017

(30) Foreign Application Priority Data
Jan. 16, 2015 (BE) 2015/0058

(51) Int. Cl. H02P 25/18; H02P 9/40; H02P 25/086; H02K 19/10; H02K 3/28; H02P 25/092; H02K 21/16; H02K 16/04; H02P 6/182

(52) U.S. Cl. CPC H02P 25/188; H02K 3/28; H02P 9/40; H02P 25/086; H02P 25/092; H02K 19/103; H02K 16/04; H02P 6/182; H02K 21/16

(57) ABSTRACT

The invention involves a switched reluctance motor, comprising a stator and a rotor rotatable relative to the stator. The stator comprises several circumferentially arranged coils and stator poles, the stator poles forming the cores of the coils. The rotor comprises several counter poles for interacting with the stator poles for applying a reluctance torque on the rotor. The motor comprises phase inputs for receiving an actuation signal for actuating one or more phase stages. Each stator coil is associated with a phase stage, such that each phase stage comprises at least two coils. Each phase stage comprises a circuit stage including a switching arrangement comprising switches for selectively switching the coils of said phase stage in either one of a parallel, a serial, or a parallel-serial electrical configuration.

### FIELD OF THE INVENTION

The present invention is directed at a switched reluctance motor, comprising a stator and a rotor, the rotor being rotatable relative to the stator, wherein the stator comprises a plurality of coils and stator poles arranged circumferentially around the rotor, the stator poles forming the cores of the coils, and wherein the rotor comprises a plurality of counter poles for interacting with the stator poles of the stator for applying a reluctance torque on the rotor, wherein the motor comprises one or more phase inputs for receiving an actuation signal for actuating a respective phase stage of one or more phase stages of the motor. The invention is further directed at an apparatus including such a switched reluctance motor, a vehicle, and a method of operating a switched reluctance motor.

### BACKGROUND

A switched reluctance motor (SR motor) is a type of electric motor that is driven by reluctance torque on a rotor that is arranged rotatable with respect to a stator. In an SR motor, coils for generating the required magnetic field are included on the stator. A number of salient stator poles, which are salient with respect to the circumference of the stator towards the rotor, form the cores of the coils. The rotor comprises a number of passive salient counter poles, which counter poles are salient towards the stator. Thus the stator poles on the stator and the counter poles on the rotor may typically be formed as salient structures on the periphery of the stator and rotor, the stator poles extending in the direction towards the rotor and the rotor poles extending in the direction towards the stator. As may be appreciated, the stator may be arranged concentrically around the rotor or vice versa.

The counter poles, which are usually arranged circumferentially around the periphery of the rotor in a plane perpendicular to the axis of rotation, receive the magnetic field provided by the stator poles. Typically, the number of counter poles deviates from the number of stator poles, such that at any position of the rotor relative to the stator, at least some of the counter poles are unaligned relative to their most nearby stator poles on the stator.

Torque is generated when a counter pole is not in alignment with a stator pole of an actuated coil on the stator; i.e. the counter pole momentarily having an angular displacement relative to the actuated coil. In establishing the most advantageous energetic situation of minimal potential energy, this is the situation of perfect alignment between the stator pole of the actuated coil and the respective counter pole where the magnetic reluctance is minimized, a magnetic force acts on the counter pole pulling it towards the stator pole—thereby inducing the desired torque.

To continue inducing a torque on the rotor, coils may be actuated sequentially or in groups such that each time one or more coils are actuated the stator poles of which are in slight angular displacement relative to the nearest counter poles on the rotor. This may for example be achieved in a multiphase arrangement, wherein the coils are powered by being sequentially activated.

Advantageously, in an SR motor, the absence of coil windings on the rotor eliminates the use of brush contacts that are prone to wear. The only induced heat in the rotor is caused by friction losses and iron losses; there are no copper losses generated such as with induction motors, hence less cooling is required. Compared to an induction motor, the SR motor has a simple design without induction windings on the rotor. Compared to permanent magnet motors, an important advantage is simply the absence of permanent magnets in the SR motor. In particular, cost and supply concerns regarding the limited reserves of rare earth magnets are a limiting factor for application of permanent magnet motors in a scenario of worldwide electrification of mobility. Also, permanent magnets suffer from demagnetization caused by heat and excessive magnetic fields.

A known complexity in the design of SR motors is that dependent on the rotational velocity of the rotor, different design criteria and requirements may exist with respect to the amount of torque desired. The maximum torque of SR motors is naturally limited by the available voltage and maximum allowed phase current. At relatively low speeds, the torque is limited by the maximum allowed phase current; at higher speeds, due to the increasing back-emf and decreasing commutation time, maximum phase current can't be forced in a phase anymore. Maximum phase current and thus torque drops gradually as the speed increases. Increasing the maximum achievable torque considering the same voltage and maximum phase current constrains, is a desirable property.

### SUMMARY OF THE INVENTION

It is an object of the present invention to provide a switched reluctance motor operable at variable speed, and being switchable into different torque transmission states to adapt motor behavior dependent on operational conditions.

To this end, there is provided herewith a switched reluctance motor, comprising a stator and a rotor, the rotor being rotatable relative to the stator, wherein the stator comprises a plurality of coils and stator poles arranged circumferentially around the rotor, the stator poles forming the cores of the coils, and wherein the rotor comprises a plurality of counter poles for interacting with the stator poles of the stator for applying a reluctance torque on the rotor, wherein the motor comprises one or more phase inputs for receiving an actuation signal for actuating a respective phase stage of one or more phase stages of the motor, wherein each coil of the plurality of coils of the stator is associated with one said phase stage of the motor such that each phase stage comprises at least two of the coils, and wherein each phase stage comprises a circuit stage including a switching arrangement comprising a plurality of switches for selectively switching the coils associated with said phase stage in either one of a parallel, a serial, or a parallel-serial electrical configuration.

In the switched reluctance motor of the present invention, the coils of each phase stage of the motor are switchable into either one of a serial, parallel or parallel-serial electric configuration. The switching of the coils in different configurations in this manner directly influences the behavior of the motor at different rotational speeds of the rotor. For example, when all coils in a phase stage are connected in series, the full current of a supplied direct current (e.g. as actuation signal) of that phase stage is conveyed through each coil. Therefore, strong magnetic fields are generated in these coils giving rise to a large induced torque. However, at higher rotational speeds of the rotor, torque quickly drops as a result of increased counter-electromotive force resulting from the increased variation in magnetic field due to the relative motion between the stator poles and the counter poles (back-EMF) and shorter commutation periods. Shorter commutation periods due to higher rotational velocity result in less time available for the current to build up. On the other hand, in a parallel configuration of the coils, the current will be distributed between the coils. Thus, the lower current through the coils will provide a smaller amount of induced torque. However, the delivered torque can be better sustained at higher rotational speeds. This is because the lower back electromotive force combined with the lower phase inductance better enable to force current in operation. The parallel-serial configuration comprises both coils that are connected in series, as well as parallel legs of coils. This configuration may form a bridge between the serial and the parallel configuration.

By enabling switching of the electric configuration of a phase stage dependent on the speed of the rotor, more torque can be induced at low velocities while still allowing a sufficient amount of torque to be sustained at higher speeds for given phase current and voltage constraints. The electric configuration is switched in order to apply the optimal amount of torque dependent on the velocity. As a result, as compared to a conventional fixed configuration of coils, the same amount of torque at low velocities can be obtained using lower phase currents while the required amount of torque can be sustained for higher velocities. The motor may thus deliver a same amount of torque at a lower phase current, or in case the maximum allowed phase current remains the same it can deliver more torque at the same phase current level as compared to a conventional situation. Additionally, dependent on the speed of the rotor and the amount of torque desired at a given speed, this may be obtainable via more than one of the available electric configurations. This provides an additional degree of freedom during operation. In such cases, the electric configuration may be selected for example such that the motor produces the least amount of sound, or is more efficient, or to optimize for other behavior of the motor.

The switching into different electric configurations, dependent on operational conditions (such as audible motor noise, efficiency or rotor speed), may be used in a similar manner as the switching into various gears in a vehicle with a conventional combustion engine. Therefore, hereinafter, in accordance with this analogy reference is sometimes made to ‘gears’ or the switching into such gears. Wherever this terminology is used, the term ‘gear’ or ‘gears’ in accordance with this analogy refers to the switching of the electrical configurations in accordance with the present invention.

As may be appreciated, the serial parallel configuration may be embodied differently dependent on the specifics of the motor. For example, in a phase stage comprising four coils, the parallel-serial configuration may consist of two coil pairs in a parallel configuration wherein the coils of each pair are in series connection. But in a phase stage consisting of six coils, two groups of three coils may be connected in parallel with the coils in each group being connected in series. Alternatively in a phase stage consisting of six coils, three coil pairs may be connected in a parallel configuration with the coils in each pair connected in series. The both embodiments of phase stages with six coils taken as example above will show a different behavior in a torque-speed diagram: the version with most coils in series will provide more torque at lower speeds, and the version with most parallel groups (or pairs) will produce more torque at higher speeds. As understood, even more configuration may be created with more coils per phase stage, enabling creation of more gears in the transmission system. In accordance with an embodiment (in line with the above exemplary parallel-serial configurations) in said serial-parallel electrical configuration, the phase stage comprises at least three coils, wherein at least two coils of said phase stage are electrically operated in a serial configuration with respect to each other, and wherein at least two of said coils of said phase stage are electrically operated in a parallel configuration with respect to each other. The number of coils, stator poles or counter poles is not limited in any way, and can be selected dependent on the requirements and needs for a specific application. As may be appreciated, if only a parallel and a serial mode is to be made available, this may be obtained by applying at least two coils. For the parallel-serial mode, at least three coils are required. Of course, any number of coils may be applied.

Moreover, in a further embodiment of the present invention the switched reluctance motor further includes a controller, wherein the controller is arranged for obtaining data indicative of an operational condition of the motor and for operating the switches of each phase stage dependent on the operational condition of the motor; wherein the data indicative of the operational condition of the motor is obtained by at least one of a group comprising: a sensor unit providing a sensor signal; said controller or an additional control unit being arranged for providing said data based on a calculation.

For example, the switched reluctance motor may include a sensor unit and a controller, wherein the sensor unit is arranged for providing a sensor signal to the controller, the sensor signal being indicative of a rotational speed of the rotor. The controller may be arranged for operating the switches of each phase stage dependent on the sensor signal. This embodiment provides an automatic transmission system that changes gear automatically dependent on the speed of the rotor. As will be appreciated, alternatively switching may be implemented manually requiring the operator (or driver in a vehicle) to decide when to switch gear. However, although workable, switching automatically based on the sensor signal indicative of the rotational speed enables to switch at an optimal moment in time, improving overall optimization of the parameters of interest.

It should be appreciated that it is not a requirement that switching is performed on speed. Other operational parameters of the motor may be used for switching, such as (but not limited to) delivered torque, efficiency or motor sound (noise). Also the abovementioned sensor unit is not an explicit requirement, as in many embodiments it is possible to calculate the desired operational parameters from information already available to (or made available to) the controller. The controller could for example calculate the rotor speed or the delivered torque based on power usage (e.g. dependent on the present used configuration (parallel, serial, parallel-serial)). Any of these embodiments may be applied for controlling switching and are within the scope of the claimed invention.

In accordance with an embodiment, the controller is arranged for switching the coils of each phase stage such as to operate the phase stage in a serial configuration of the coils when the sensor signal indicates a speed smaller than a first threshold. In accordance with a further embodiment, the controller is arranged for switching the coils of each phase stage such as to operate the phase stage in a parallel configuration of the coils when the sensor signal indicates a speed larger than a second threshold. In principle, in accordance with some embodiments, the first and second threshold may be equal—in fact providing a direct transition from the serial configuration to the parallel configuration without anything in between. This embodiment may for example lack the parallel-serial configuration of coils, resulting in only to gears (low speed/high speed).

Yet in accordance with another embodiment, the second threshold is larger than or equal to the first threshold; and the controller is arranged for switching the coils of each phase stage such as to operate the phase stage in a parallel-serial configuration of the coils when the sensor signal indicates a speed between the first and second threshold, when the second threshold is larger than the first threshold. In this embodiment, where the first and second threshold are not equal, the parallel-serial configuration provides an in-between gear for intermediate speeds.

Yet in even further embodiments, the controller is arranged for switching the coils of each phase stage such as to switch from a first of said electrical configurations to a second of said electrical configurations dependent on a direction of change of said operational condition of the motor, wherein on a decrease of the value of the operational condition the switching is performed when the data indicates the operational condition having a value smaller than a third threshold, and on an increase of the value of the operational condition the switching is performed when the data indicates the operational condition having a value larger than a fourth threshold; the fourth threshold being larger than the third threshold.

In this embodiment, the controller is for example arranged for operating the coils of each phase stage in a serial configuration when for example the speed (or other operational condition evaluated) is smaller than the fourth threshold while the speed is increasing. Upon exceeding the fourth threshold, the coils of the phase stage are switched into the serial-parallel configuration. However, on decrease of the speed switching back such as to operate the phase stage again in the serial configuration is performed when the speed falls below a third threshold (smaller than the fourth threshold). This prevents that a repeated switching between two electrical configurations is performed when the speed is more or less kept at or around a certain average speed. Instead of speed, any of the other operational conditions may be used for switching.

The invention is not limited to two or three gears for two or three speed ranges; dependent on the number of coils in each phase stage, different implementations of parallel-serial modes may be obtained by applying suitable switching arrangement with switches. This may provide more than three gears for different speed ranges, as exemplarily referred to above for a six coil phase stage.

In accordance with an embodiment, the switches comprise at least one element of a group comprising mechanical switches, electrical switches, electromechanical switches, semiconductor type switches such as transistor type switches. Mechanical switches provide a more cost effective solution while these may be operated automatically by a controller. Electrical or semiconductor type switches may allow very fast switching, which in turn allows switching the electrical configuration of the coils of a phase stage during the time period within each cycle wherein this phase is in an inactive state and one or more other phases are in an active state. Mechanical switches have the benefit of being low cost, although they do not generally allow switching fast enough to perform during an inactivated state of the phase stage within a single cycle. Instead, with slower switches, it may be necessary to inactivate the phase stage for one or more consecutive cycles to perform the switching for that phase stage. Other phase stages may be inactivated likewise to allow switching, either simultaneously or subsequently. This latter (i.e. sequential switching) has the benefit of not completely interrupting the output torque, when changing the electrical configuration.

The number of phase stages and the number of coils, as well as the design of the coils (e.g. number of windings, specifics of the core, etc.) may vary dependent on the design and the application of the SR motor. For example, in accordance with an embodiment that may be used for an electric vehicle, the stator comprises sixteen said coils included in four phase stages such that each phase stage includes four coils. These coils may in a serial configuration by proper switching provide a series connection of four coils. In a parallel configuration, the four coils per stage are connected in parallel, and in the parallel-serial mode two coil pairs are connected in parallel, the coils in the pairs being in series.

In an embodiment, there is provided an apparatus including a switched reluctance motor as described above. In a further embodiment, there is provided a vehicle including a switched reluctance motor as described above.

In accordance with a second aspect thereof, the invention provides a method of operating a switched reluctance motor, the motor comprising a stator and a rotor, the rotor being rotatable relative to the stator, wherein the stator comprises a plurality of coils and stator poles arranged circumferentially around the rotor, the stator poles forming the cores of the coils, and wherein the rotor comprises a plurality of counter poles for interacting with the stator poles of the stator for applying a reluctance torque on the rotor, wherein the motor comprises one or more phase inputs and one or more phase stages, each phase input connected to a respective phase stage, wherein each coil of the plurality of coils of the stator is associated with one said phase stage of the motor such that each phase stage comprises at least two of the coils, the method including: receiving through at least one of said phase inputs an actuation signal for actuating said respective phase stage, and applying the actuation signal to the phase stage such as to actuate the rotor via the stator poles of said phase stage; operating, during said actuating of the rotor, a switching arrangement of each phase stage comprising a plurality of switches, such as to selectively switch the coils associated with said phase stage in either one of a parallel, a serial, or a parallel-serial electrical configuration.

In an embodiment thereof, the method further includes obtaining, using a sensor unit, a sensor signal indicative of an operational condition of the motor, and providing the sensor signal to a controller; operating, by the controller, the switches of each phase stage dependent on the sensor signal. The operational condition for which the sensor signal is indicative may comprise at least one element of a group comprising: a rotational speed of the rotor, an output power requirement of the motor, sound or sound volume produced by the motor, efficiency of an input power supplied to the motor with respect to the output power delivered by the motor. Although in the present document, reference is made to a sensor unit, this element could be embodied in different manners (e.g. including: a controller or other means that derives the desired sensor signal or information from operational conditions of various components of the motor or powertrain, or alternatively or additionally a dedicated sensor). As an alternative to the sensor unit, or in addition thereto, the controller or an additional controller unit may be arranged for providing the required data based on a calculation as already described above.

It should be appreciated that it is not a requirement that switching is performed on speed. Other operational parameters of the motor may be used for switching, such as (but not limited to) delivered torque, efficiency or motor sound (noise). Also the abovementioned sensor unit is not an explicit requirement, as in many embodiments it is possible to calculate the desired operational parameters from information already available to (or made available to) the controller. The controller could for example calculate the rotor speed or the delivered torque based on power usage (e.g. dependent on the present used configuration (parallel, serial, parallel-serial)). Any of these embodiments may be applied for controlling switching and are within the scope of the claimed invention.

Moreover, in an embodiment, the controller may operate the switches such as to switch the coils of each phase stage such as to operate the phase stage in a serial configuration of the coils when the sensor signal indicates a speed smaller than a first threshold; switch the coils of each phase stage such as to operate the phase stage in a parallel configuration of the coils when the sensor signal indicates a speed larger than a second threshold; and switch the coils of each phase stage such as to operate the phase stage in a parallel-serial configuration of the coils when the sensor signal indicates a speed between the first and second threshold.

### BRIEF DESCRIPTION OF THE DRAWINGS

The invention will further be elucidated by description of some specific embodiments thereof, making reference to the attached drawings. The detailed description provides examples of possible implementations of the invention, but is not to be regarded as describing the only embodiments falling under the scope. The scope of the invention is defined in the claims, and the description is to be regarded as illustrative without being restrictive on the invention. In the drawings:

FIG. 1 schematically illustrates a switch reluctance motor in accordance with the present invention;

FIG. 2A and FIG. 2B schematically illustrate the electric configuration of the coils of one phase stage of a switch reluctance motor in accordance with the present invention in different switching states;

FIG. 3 schematically illustrates a further electric configuration of coils in a phase stage of a switched reluctance motor in accordance with the present invention;

FIG. 4 schematically illustrates a further electric configuration of the coils of a phase stage of a switched reluctance motor in accordance with the present invention;

FIG. 5 illustrates the powering diagrams of various phase stages of a switch reluctance motor in accordance with the present invention;

FIG. 6 illustrates an alternative possible powering diagram of the phase stages of switch reluctance motor in accordance with the present invention;

FIG. 7 schematically illustrates a further alternative powering diagram of the phase stages of a switch reluctance motor of the present invention;

FIG. 8 schematically illustrates a further alternative powering diagram of the various phase stages of a switch reluctance motor in accordance with the present invention;

FIG. 9 is a schematic torque-speed diagram for a switched reluctance motor in accordance with the present invention.

### DETAILED DESCRIPTION

The figures include a large number of reference signs indicating various components, parts and/or aspects of the embodiments that are schematically illustrated. In addition, reference is made to various phase stages by referring to a phase stage number illustrated as a black dot with a number, i.e. phase stages [symbol] , [symbol] , [symbol] , and [symbol] . These phase stage numbers are not to be mistaken for the reference numerals (which include for example the motor 1, the stator 2 or the rotor 3). Therefore, the notation of the phase stage numbers [symbol] , [symbol] , [symbol] , and [symbol] is used accordingly in the description to identify the phase stages, whereas the reference numerals to the motor, stator and rotor are provided as regular numbers.

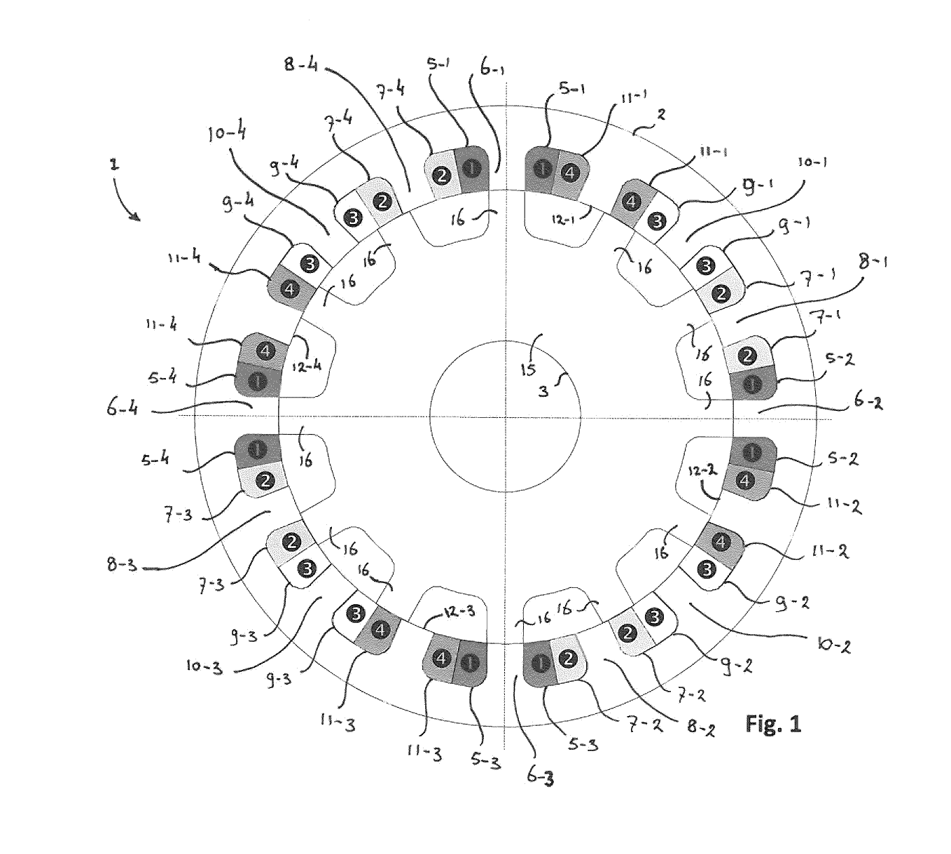

FIG. 1 schematically illustrates a switched reluctance motor in accordance with the present invention. The switched reluctance motor 1 comprises a stator 2 and a rotor 3. The rotor 3 is rotatable with respect to the stator 2, for example by suspending the rotor 3 using suitable bearings (not shown) with respect to the fixed parts of the motor. The rotatable rotor 3 comprises a central part 15 and a plurality of salient poles 16. The poles 16 are electrically passive in a sense that the poles 16 do not form the cores of (or interact with) coils on the rotor 3. The stator 2 comprises a circumferential part 4 and a plurality of salient poles 6-n, 8-n, 10-n and 12-n (wherein n is indicative of a specific coil in each phase stage, to be explained). Each pole on the stator 2 forms the core of a respective coil of the switched reluctance motor 1. The switched reluctance motor 1 comprises a plurality of coils that are divided into different groups. In the embodiment illustrated in FIG. 1, a total of 16 coils is divided into four groups. These groups are indicated as phase stages. In the embodiment of FIG. 1, a first phase stage [symbol] comprises the coils 5-1, 5-2, 5-3, and 5-4. In phase stage [symbol] coil 5-1 is wound enclosing pole 6-1 forming the core thereof. Coil 5-2 comprises pole 6-2 as its core. Coil 5-3 comprises pole 6-3 as its core, and coil 5-4 comprises pole 6-4 as its core. Likewise, the coils of phase stage [symbol] comprise coils 7-1, 7-2, 7-3 and 7-4 which respectively enclose the poles 8-1, 8-2, 8-3 and 8-4 as their cores. Phase stage [symbol] comprises coils 9-1, 9-2, 9-3 and 9-4 which are wound such as to enclose respectively the poles 10-1, 10-2, 10-3 and 10-4. Lastly, phase stage [symbol] comprises coils 11-1, 11-2, 11-3 and 11-4 respectively enclosing poles 12-1, 12-2, 12-3 and 12-4 as their cores.

Typically in a switched reluctance motor, the number of poles on the stator 2 is different from the number of poles on the rotor 3. In FIG. 1, the stator 2 comprises sixteen poles (6-n, 8-n, 10-n, and 12-n where n=1, 2, 3, 4). The rotor 3 comprises only twelve salient poles 16 circumferentially arranged around the central part 15. In this configuration, only the poles 6-1, 6-2, 6-3 and 6-4 of the first phase stage [symbol] are nicely aligned with some poles 16 of the rotor 3. The poles of each of the other phase stages [symbol] , [symbol] , and [symbol] are not aligned with any of the salient poles 16 of the rotor 3.

As will be appreciated, in case the coils of any of the phase stages [symbol] , [symbol] , or [symbol] would be powered by providing an electric current to the respective coils, the rotor poles 16 will experience a force that will pull the rotor towards a position wherein each of the poles of the activated coils is aligned with one of the poles 16 of the rotor 3. In the situation illustrated in FIG. 1, the poles 6-n of phase stage [symbol] are aligned with some of the poles 16 of the rotor 3. Therefore, activating the coils 5-n of phase stage [symbol] will not result in a rotation of the rotor 3. However, in case the coils 7-n of phase stage [symbol] will be powered by means of an electric current, instead of the coils of phase stage [symbol] , the rotor 3 will rotate until the poles 8-1, 8-2, 8-3 and 8-4 are aligned with some of the poles 16 on the rotor. As will be appreciated, the poles 8-n (n=1, 2, 3, 4) will align with the rotor poles 16 that are most nearby in the situation illustrated in FIG. 1.

Next, if subsequently the coils 7-n of phase stage [symbol] are no longer powered, and instead the coils 9-1, 9-2, 9-3 and 9-4 of phase stage [symbol] are powered with an electric current, the rotor 3 will again experience a torque that will keep the rotor 3 rotating in the clockwise direction. Subsequently, the coils 9-n are no longer powered and the coils 11-1, 11-2, 11-3 and 11-4 of phase stage [symbol] are powered to keep the rotor 3 rotating. As will be appreciated, by subsequently activating the coils of phase stages [symbol] , [symbol] , [symbol] and [symbol] , and repeating this activation pattern, the switch reluctance motor 1 can be operated. In FIG. 1, the switch reluctance motor 1 is illustrated comprising a rotor 3 rotating inside a stator 2. As will be appreciated, alternatively, the stator may also be located on the inside and the rotor on the outside (circumferentially around the stator) in a rotatable manner.

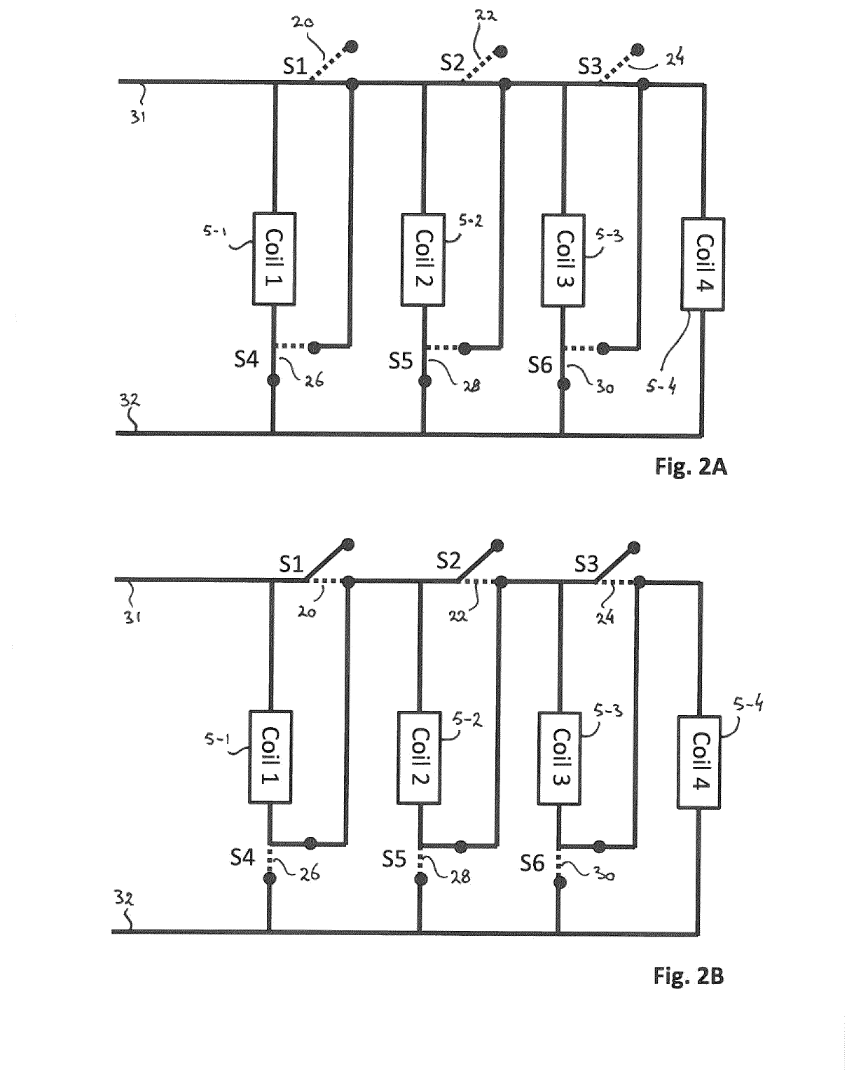

In accordance with the present invention, to operate to coils 5-1, 5-2, 5-3 and 5-4 of the first phase stage [symbol] , an electric configuration in accordance with a first embodiment of the invention is illustrated in FIGS. 2A and 2B. In FIG. 2A, the configuration is illustrated including switches S1-S6 in a first switching position such as to obtain a parallel electric configuration of the coils 5-n. The configuration illustrated in FIGS. 2A and 2B comprises the coils 5-1, 5-2, 5-3 and 5-4, as well as a plurality of switches S1 20, S2 22, S3 24, S4 26, S5 28 and S6 30. Connection of terminals 31 and 32 allow to connect the phase stage [symbol] to a power supply. The power supply may be a current source or any other suitable type of power supply that allows to regulate the current provided to the coils 5-n.

In the situation of FIG. 2A, the switches 20, 22 and 24 (S1, S2 and S3) are in a closed position. The switches 26, 28 and 30 (S4, S5 and S6) respectively connect coils 5-1, 5-2 and 5-3 with connection terminal 32. In this configuration, as follows from FIG. 2A, the coils 5-1, 5-2, 5-3 and 5-4 between the connection terminals 31 and 32 are arranged in an electrically parallel configuration.

In the situation of FIG. 2B, switches 20, 22 and 24 (S1, S2 and S3) are in an open position, while switches 26, 28 and 30 (S4, S5 and S6) respectively connect coil 5-1 with coil 5-2, coil 5-2 with coil 5-3, and coil 5-3 with coil 5-4. Therefore, in situation illustrated in FIG. 2, the coils are in a serial electric configuration with respect to the connection terminals 31 and 32.

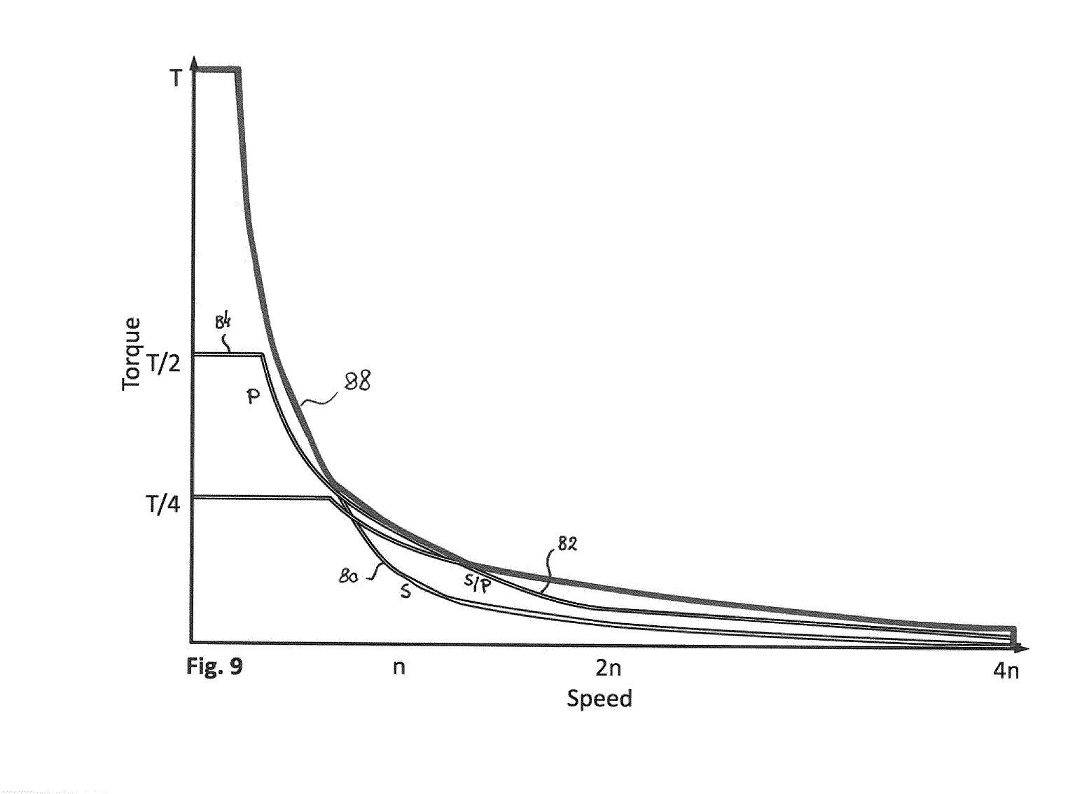

As will be appreciated, if a current is applied between the connection terminals 31 and 32, in the parallel configuration of FIG. 2A. This current is divided between the coils 5-1, 5-2, 5-3 and 5-4. Therefore, each coil only receives part of the current which is applied between the connection terminals 31 and 32. On the other hand, in the situation of FIG. 2B, where the coils 5-n are in a serial electric configuration with respect to the connection terminals 31 and 32, the full current applied between the connection terminals 31 and 32 is received by each coil 5-1, 5-2, 5-3 and 5-4. The magnetic field generated by each coil is dependent on the electric current flowing through the coil. Therefore, in the parallel situation of FIG. 2A, the magnetic field provided by each of the coils 5-1 through 5-4 is smaller than in the serial electric configuration of FIG. 2B (wherein the electric current is much larger through each coil). However at the same time, at the parallel configuration of FIG. 2A the voltage across each of the coils 5-1, 5-2, 5-3 and 5-4 is much larger than in the situation of FIG. 2B. In the serial configuration of FIG. 2B, the voltage across each of the coils 5-1 through 5-4 is divided over the coils. As a result of these differences, due to the large magnetic field obtainable in the situation of FIG. 2B, in the serial configuration of FIG. 2B the powering of the coils 5-n enable to apply a large substantial torque onto the rotor 3 of FIG. 1. As described before, the maximum torque that can be applied is naturally limited by the available voltage and maximum allowed phase current. At relatively low speeds, the torque is limited by the maximum allowed phase current; at higher speeds, due to the increasing back-emf and decreasing commutation time (as the rotor speed increases), maximum phase current can't be forced in the phase stage anymore. Maximum phase current and thus torque drops gradually as the speed increases. For the serial configuration in FIG. 2B, although the torque that can be applied at low speeds will be higher, the influence of back-emf and decreasing commutation time at higher speeds are more severe than in the parallel configuration of FIG. 2A. Therefore, as also follows for example from curves 80 (for serial) and 84 (for parallel) in FIG. 9, the amount of torque that can be applied at higher speeds will be lower for the serial configuration of FIG. 2A in comparison to the parallel configuration of FIG. 2B, ceterus paribus.

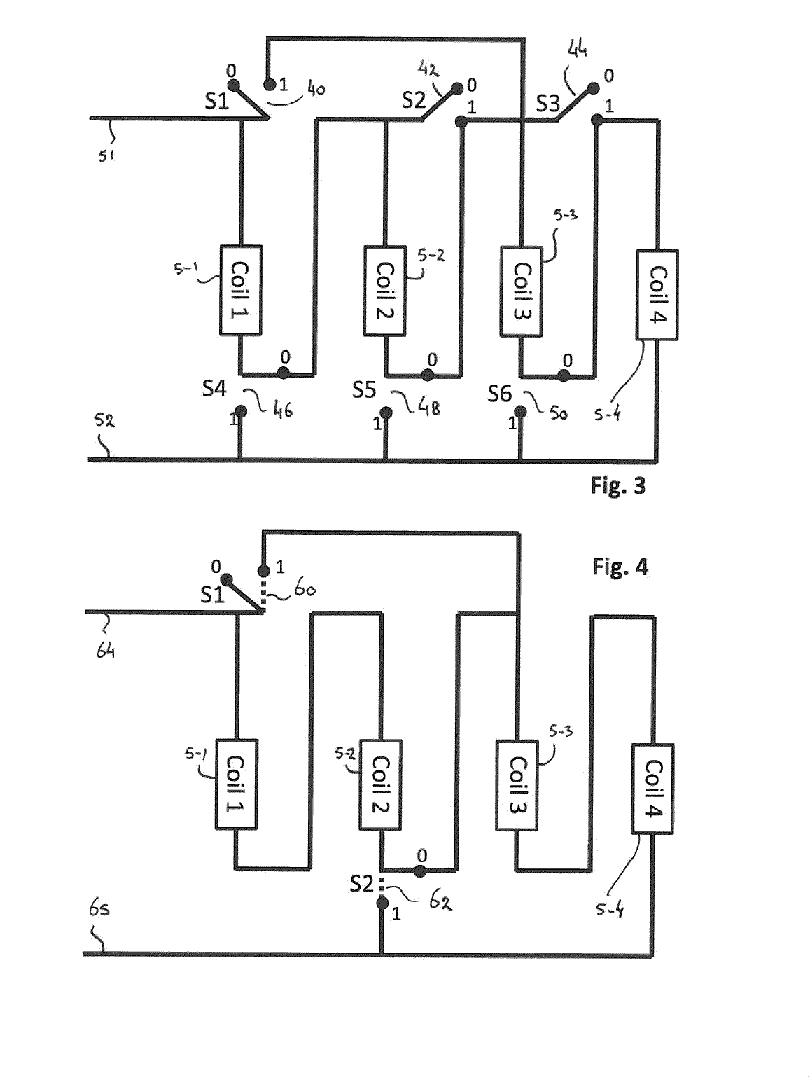

A further electric configuration of the coils 5-n of the first phase stage [symbol] is illustrated in FIG. 3. In the configuration of FIG. 3 the switches of S1 through S6, respectively switch 40, 42, 44, 46, 48 and 50 are in a switching arrangement such that the coils 5-1, 5-2, 5-3 and 5-4 are in a electric serial configuration. However, by switching switch 40 (S1) into position ‘1’ while also switching switch (S5) 48 into position ‘1’, a configuration is obtained wherein coils 5-1 and 5-2 are serial with respect to each other while at the same time coils 5-3 and 5-4 are serial with respect to each other, but these pairs of coils (on one hand coils 5-1 and 5-2 and on the other hand coils 5-3 and 5-4) are parallel with respect to each other. Therefore, this switching arrangement wherein switches 40 and 48 (S1 and S5) are in position ‘1’ while all other switches 42, 44, 46 and 50 are in switching position ‘0’, is a hybrid configuration indicative as serial/parallel configuration. Moreover, the full parallel configuration wherein all of the coils 5-1 through 5-4 are parallel with respect to each other is achieved by switching all of the switches 40, 42, 44, 46, 48 and 50 into position ‘1’. The serial configuration is obtained by switching all of the switches 40, 42, 44, 46, 48, and 50 into position ‘0’. As a result, the configuration illustrated in FIG. 3 allows a serial mode, a parallel mode and a serial/parallel mode. In addition to what has been explained above for the serial mode and for the parallel mode, the behavior of the maximum torque that may be applied at a given speed in the serial/parallel mode is somewhere in between the behavior of the maximum torque that can be applied at that given speed in the serial mode and in the parallel mode. This results in a torque-speed curve for serial-parallel configuration such as is exemplarily illustrated by curve 82 in FIG. 9. Therefore the configuration of FIG. 3 provides an advantageous electrical configuration for three different rotation speeds. Low speed (serial, intermediate speed (serial/parallel) and high speed (parallel)). A further alternative electric configuration is illustrated in FIG. 4. In the illustration of FIG. 4 between the connection terminals 64 and 65 coils 5-1 and 5-2 are always serial with respect to each other. At the same time, coils 5-3 and 5-4 are also always serial with respect to each other. However, by selectively switching switch 60 (S1) and switch 62 (S2) in either position ‘0’ or ‘1’, either the serial mode or the serial/parallel mode can be obtained.

As will be appreciated, the electric configuration of each phase stage [symbol] , [symbol] , [symbol] and [symbol] may preferably be the same for the switched reluctance motor. Selectively, dependent on the speed of the rotor, the configuration may be switched into a serial mode, a parallel mode, or a serial/parallel mode. Although FIGS. 2A, 2B, 3 and 4 provide the schematic electric configuration for phase stage [symbol] , the circuitry for the other phase stages [symbol] , [symbol] , [symbol] will be kept the same as that for group [symbol] . The switches applied for switching the electric configuration could be of any desired type. However, the skilled person will understand that different types of switches each have their own advantages and disadvantages that will render them suitable or unsuitable in certain applications. For example, electro-mechanical switches may be relatively inexpensive, while still fast enough to perform switching in a number of situations. At the same time, such electro-mechanical switches are prone to wear and require maintenance while the switching itself cannot be performed very fast. On the other hand, semiconductor based switches such as transistor type switches allow very fast switching during operation of the respective phase stages [symbol] , [symbol] , [symbol] and [symbol] , even without having to interrupt activation of the coils. However semiconductor based switches are more expensive than mechanical switches.

FIG. 5 schematically illustrates a power diagram for powering the coils of each of the phase stages [symbol] , [symbol] , [symbol] and [symbol] . Horizontally, the diagram indicates the repetition pattern of the powering sequence. During each cycle, the coils of each phase stage [symbol] , [symbol] , [symbol] and [symbol] will be powered for a brief moment 70, and will not be powered in the meantime during period 71 (as indicated for phase stage [symbol] ). As follows from FIG. 5, the applied phase current will always be in a same direction through the phase stage when the phase stage is powered during periods 70, and no current is applied during the periods 71 wherein the phase stages are not powered. However, as follows from the diagram of FIG. 5, the powering of each of the phase stages [symbol] , [symbol] , [symbol] , [symbol] is performed sequentially starting with phase stage [symbol] , followed by [symbol] , [symbol] and [symbol] . Using semiconductor switches in the configurations illustrated in FIGS. 2A, 2B, 3 and 4, the switching can be performed sufficiently fast such that the powering of the coils does not have to be interrupted. For example, each of the phase stages [symbol] , [symbol] , [symbol] , and [symbol] can be switched into a different mode (serial, parallel, serial/parallel) during the inactive period 71. Therefore, the switching of the electric configuration into a different mode can be performed during a single cycle, such that all phase stages operate in the same electric configuration in the next cycle.

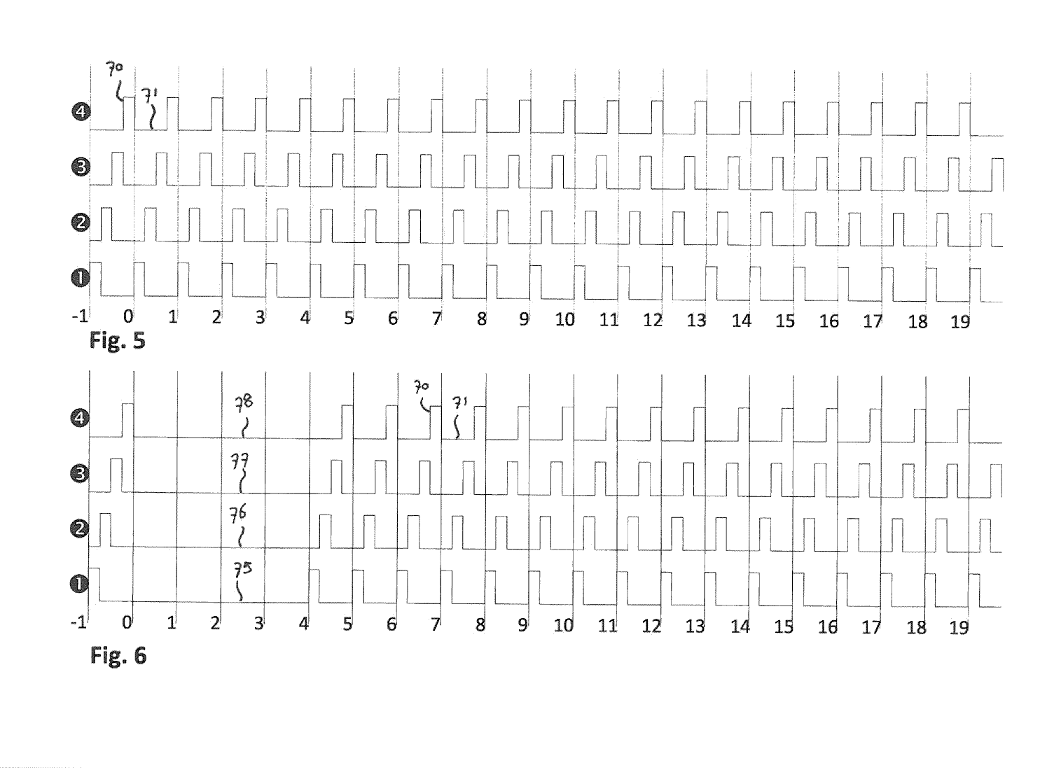

If, alternatively, switches are used that do not allow the switching to be performed very fast, for example mechanical switches or electro-mechanical switches, the switching towards a different electrical mode can be performed in a different manner. Various alternative switching methods are illustrated in FIGS. 6, 7 and 8 respectively. In FIG. 6, the powering of the coils in each phase stage [symbol] , [symbol] , [symbol] and [symbol] must be interrupted for a number of cycles to allow switching of the electric circuitry into the correct mode of operation. This is performed during the interruption indicated by periods 75, 76, 77 and 78 in FIG. 6. After having switched the electric circuitry into the desired configuration, the sequential powering of the different phase stages [symbol] , [symbol] , [symbol] and [symbol] continues.

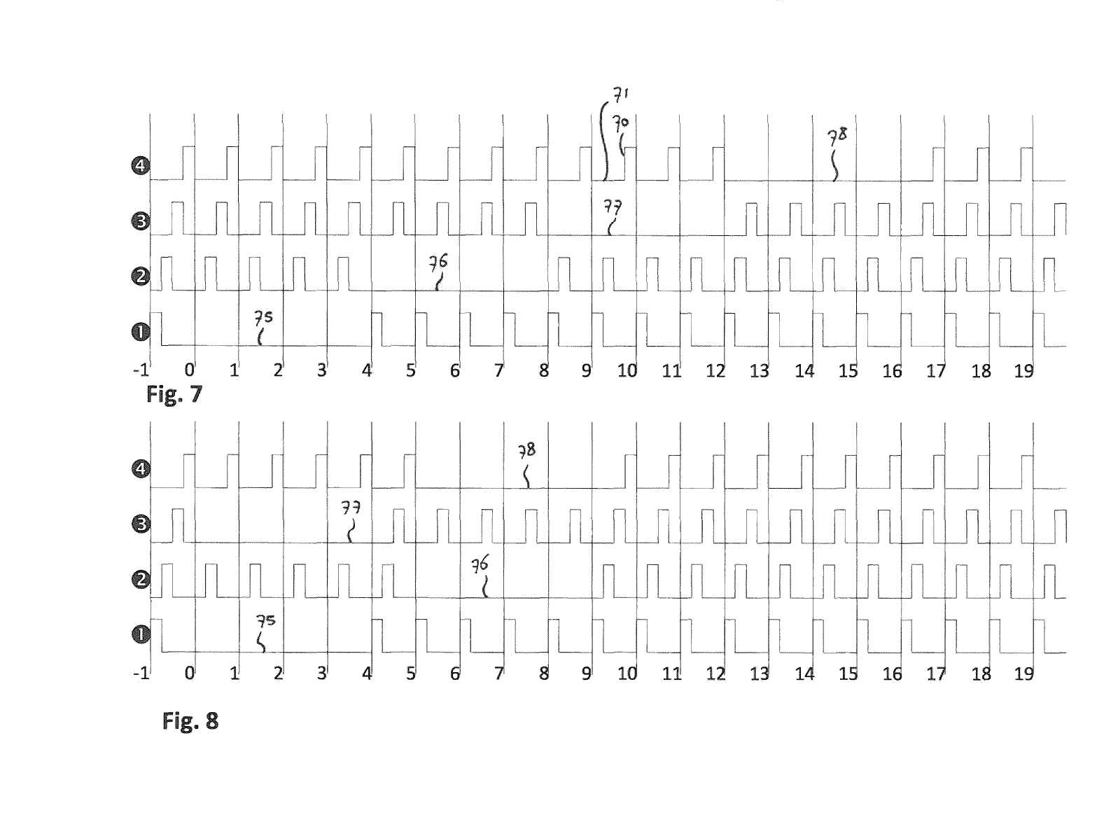

In FIG. 7, each of the phase stages [symbol] , [symbol] , [symbol] and [symbol] is temporarily inactivated during the switching of this phase stage into the new electric configuration desired. Therefore, the inactive period 75 for switching phase stage [symbol] is followed by an inactive period 76 for switching [symbol] , which is followed by an inactive period 77 for [symbol] and an inactive period 78 for [symbol] . As a further alternative, as illustrated in FIG. 8, phase stages [symbol] and [symbol] are simultaneously switched into a new electric configuration during simultaneous inactive periods 75 and 77, while phase stages [symbol] and [symbol] are thereafter switched into the new electric configuration during inactive periods 76 and 78. The skilled person will appreciate that the manner of switching the phase stages [symbol] , [symbol] , [symbol] and [symbol] is not limited by the specific methods illustrated in FIGS. 5-8, but can be performed in any other desired manner.

FIG. 9 illustrates a schematic torque-speed representation that may be obtained by a switch reluctance motor in accordance with the present invention. The diagram of FIG. 9 illustrates the torque-speed characteristic 80 obtainable in the serial mode (S). As can be seen, a very high amount of torque (T) can be obtained at low speed, but this amount of torque quickly drops with increasing speed. A further torque-speed characteristic for the serial parallel mode is indicated by 82 (S/P). Here, the maximum amount of torque (T/2) obtainable is less than the torque that is obtainable in the serial mode (note that T/2 is used here as an exemplary value, but is not to be considered as characteristic or typical for a serial-parallel mode as compared to a serial mode in general), but a fair amount of torque can be maintained much longer at higher speeds. The torque-speed characteristic in the parallel mode is indicated with the reference numeral 84. A maximum amount of torque available in this configuration at low speed is only a quarter of that in the serial configuration (T/4) (again also here, note that T/4 is used here as an exemplary value, but is not to be considered as characteristic or typical for a parallel mode as compared to a serial mode in general). However, the amount of torque can be maintained much longer at higher speeds in comparison with the serial configuration and the serial-parallel configuration. Therefore, if switching between the various electric mode serial, serial/parallel and parallel is performed at suitably chosen velocities, the maximum amount of torque obtainable dependent on the velocity of the rotor is indicated by the envelope curve 88. In reality, the amount of torque applied at each speed may be different from that indicated by curve 88. For example, also the efficiency of the switched reluctance motor or the amount of sound produced by the motor at various speeds will be decisive for choosing the correct electric configuration.

The present invention has been described in terms of some specific embodiments thereof. It will be appreciated that the embodiments shown in the drawings and described herein are intended for illustrated purposes only and are not by any manner or means intended to be restrictive on the invention. It is believed that the operation and construction of the present invention will be apparent from the foregoing description and drawings appended thereto. It will be clear to the skilled person that the invention is not limited to any embodiment herein described and that modifications are possible which should be considered within the scope of the appended claims. Also kinematic inversions are considered inherently disclosed and to be within the scope of the invention. In the claims, any reference signs shall not be construed as limiting the claim. The term ‘comprising’ and ‘including’ when used in this description or the appended claims should not be construed in an exclusive or exhaustive sense but rather in an inclusive sense. Thus the expression ‘comprising’ as used herein does not exclude the presence of other elements or steps in addition to those listed in any claim. Furthermore, the words ‘a’ and ‘an’ shall not be construed as limited to ‘only one’, but instead are used to mean ‘at least one’, and do not exclude a plurality. Features that are not specifically or explicitly described or claimed may be additionally included in the structure of the invention within its scope. Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention.

The invention may be applied in single phase or multiphase switched reluctance motors, and is not limited to any particular number of phase stages. Additions, deletions, and modifications within the purview of the skilled person may generally be made without departing from the spirit and scope of the invention, as is determined by the claims. The invention may be practiced otherwise then as specifically described herein, and is only limited by the appended claims.

1. Switched reluctance motor, comprising a stator and a rotor, the rotor being rotatable relative to the stator, wherein the stator comprises a plurality of coils and stator poles arranged circumferentially around the rotor, the stator poles forming the cores of the coils, and wherein the rotor comprises a plurality of counter poles for interacting with the stator poles of the stator for applying a reluctance torque on the rotor, wherein the motor comprises one or more phase inputs for receiving an actuation signal for actuating a respective phase stage of one or more phase stages of the motor for powering of the one or more phase stages in accordance with a repetition pattern of a powering sequence, wherein each coil of the plurality of coils of the stator is associated with one said phase stage of the motor such that each phase stage comprises at least two of the coils, and wherein each phase stage comprises a circuit stage including a switching arrangement comprising a plurality of switches for selectively switching the coils associated with said phase stage in either one of a parallel, a serial, or a parallel-serial electrical configuration;
wherein the switches include mechanical switches or electro-mechanical switches, and wherein the motor further includes a controller configured for obtaining data indicative of an operational condition of the motor and for operating the switches of each phase stage dependent on the operational condition of the motor, further configured for performing the switching of each phase stage by inactivating during an interruption the powering of the respective phase stage for a plurality of cycles of the repetition pattern of the powering sequence.

2. Switched reluctance motor according to claim 1, wherein in said serial-parallel electrical configuration, the phase stage comprises at least three coils, wherein at least two coils of said phase stage are electrically operated in a serial configuration with respect to each other, and wherein at least two of said coils of said phase stage are electrically operated in a parallel configuration with respect to each other.

3. Switched reluctance motor according to claim 1, wherein the data indicative of the operational condition of the motor is obtained by at least one of a group comprising: a sensor unit providing a sensor signal; said controller or an additional controller unit being arranged for providing said data based on a calculation, wherein the operational condition comprises at least one element of a group comprising: a rotational speed of the rotor, an output power requirement of the motor, sound or sound volume produced by the motor, efficiency of an input power supplied to the motor with respect to the output power delivered by the motor.

4. Switched reluctance motor according to claim 3, wherein the controller is arranged for at least one of:
switching the coils of each phase stage such as to operate the phase stage in a serial configuration of the coils when the data indicates the operational condition having a value smaller than a first threshold; or
switching the coils of each phase stage such as to operate the phase stage in a parallel configuration of the coils when the data indicates the operational condition having a value larger than a second threshold.

5. Switched reluctance motor according to claim 4, wherein the second threshold is larger than or equal to the first threshold; and
wherein the controller is arranged for switching the coils of each phase stage such as to operate the phase stage in a parallel-serial configuration of the coils when the data indicates the operational condition having a value between the first and second threshold, when the second threshold is larger than the first threshold.

6. Switched reluctance motor according to claim 3, wherein the controller is arranged for switching the coils of each phase stage such as to switch from a first of said electrical configurations to a second of said electrical configurations dependent on a direction of change of said operational condition of the motor, wherein on a decrease of the value of the operational condition the switching is performed when the data indicates the operational condition having a value smaller than a third threshold, and on an increase of the value of the operational condition the switching is performed when the data indicates the operational condition having a value larger than a fourth threshold; the fourth threshold being larger than the third threshold.

7. Switched reluctance motor according to claim 1, wherein the controller is configured for switching and interrupting of at least two phase stages during simultaneous interruptions.

8. Switched reluctance motor according to claim 1, wherein the controller is configured for switching and interrupting of at least two phase stages during sequential interruptions.

9. Apparatus comprising a switched reluctance motor in accordance with claim 1, wherein said apparatus is vehicle.

10. Method of operating a switched reluctance motor, the motor comprising a stator and a rotor, the rotor being rotatable relative to the stator, wherein the stator comprises a plurality of coils and stator poles arranged circumferentially around the rotor, the stator poles forming the cores of the coils, and wherein the rotor comprises a plurality of counter poles for interacting with the stator poles of the stator for applying a reluctance torque on the rotor, wherein the motor comprises one or more phase inputs and one or more phase stages, each phase input connected to a respective phase stage, wherein each coil of the plurality of coils of the stator is associated with one said phase stage of the motor such that each phase stage comprises at least two of the coils, the method including:
receiving through at least one of said phase inputs an actuation signal for actuating said respective phase stage, and applying the actuation signal to the phase stage such as to actuate the rotor via the stator poles of said phase stage for powering of the one or more phase stages in accordance with a repetition pattern of a powering sequence;
operating, during said actuating of the rotor, a switching arrangement of each phase stage comprising a plurality of switches, such as to selectively switch the coils associated with said phase stage in either one of a parallel, a serial, or a parallel-serial electrical configuration, the switches including mechanical switches or electro-mechanical switches;
obtaining, by a controller, data indicative of an operational condition of the motor; and operating, by the controller, the switches of each phase stage dependent on the operational condition of the motor, wherein the switching of each phase stage is performed by inactivating during an interruption the powering of the respective phase stage for a plurality of cycles of the repetition pattern of the powering sequence.

11. Method according to claim 10, further including:
obtaining, using a sensor unit, a sensor signal indicative of an operational condition of the motor, and providing the sensor signal to a controller;
operating, by the controller, the switches of each phase stage dependent on the sensor signal.

12. Method according to claim 11, wherein the operational condition for which the sensor signal is indicative comprises at least one element of a group comprising: a rotational speed of the rotor, an output power requirement of the motor, sound or sound volume produced by the motor, efficiency of an input power supplied to the motor with respect to the output power delivered by the motor.

13. Method according to claim 11, wherein the controller operates the switches such as to:
switch the coils of each phase stage such as to operate the phase stage in a serial configuration of the coils when the sensor signal indicates the operational condition having a value smaller than a first threshold;
switch the coils of each phase stage such as to operate the phase stage in a parallel configuration of the coils when the sensor signal indicates the operational condition having a value larger than a second threshold; and
switch the coils of each phase stage such as to operate the phase stage in a parallel-serial configuration of the coils when the sensor signal indicates the operational condition having a value between the first and second threshold.

14. Method according to claim 10, wherein the switching and interrupting by the controller is performed for at least two phase stages during simultaneous interruptions.

15. Method according to claim 10, wherein the switching and interrupting by the controller is performed for at least two phase stages during simultaneous interruptions.
